(19) United States
(12) Patent Application Publication
(10) Pub. No.: US 2013/0293331 A1
(43) Pub. Date: Nov. 7, 2013

(54) COMPONENT FOR CLAMPING CHOKE TO CHASSIS

(71) Applicant: CONTROL TECHNIQUES LTD, Newtown (GB)

(72) Inventors: Troy WINSAND, Eden Prairie, MN (US); Jonathan HOLMAN, Newtown (GB); Arthur COLOMBO, Eden Prairie, MN (US); Charles Anthony CACHIA, Welshpool (GB)

(73) Assignee: CONTROL TECHNIQUES LTD, Newtown (GB)

(21) Appl. No.: 13/789,869

(22) Filed: Mar. 8, 2013

Related U.S. Application Data
(60) Provisional application No. 61/642,160, filed on May 3, 2012.

(51) Int. Cl. H01F 27/06

(52) U.S. Cl. CPC H01F 27/06
USPC 336/67; 403/373; 29/525.01

(57) ABSTRACT

A clamp for a choke is provided, the clamp comprising a component configured to hold a choke and at least one electrical connector receiving element for receiving one or more electrical connectors of a choke. The clamp is fitted to the choke and then the assembly is fitted into a device, such as a chassis.

### CROSS REFERENCE TO RELATED APPLICATIONS

This application claims the benefit of U.S. Provisional Application No. 61/642,160 filed on May 3, 2012. The entire disclosure of the above application is incorporated herein by reference.

### FIELD

The disclosure relates to a component for clamping one or more chokes to a chassis and to a method for clamping one or more chokes to a chassis.

### BACKGROUND

A choke is a coil of insulated wire typically wound on a magnetic core and used as a passive inductor to block higher-frequency alternating current in an electrical circuit. There is a problem in fixing chokes into chassis and making electrical connections to associated printed circuit boards (PCBs). For instance, the assembly and magnetic nature of a choke means that chokes seldom have mechanical features that allow a choke to be fixed in place on a chassis.

### SUMMARY

The scope of protection afforded by this disclosure is set out in the claims.

According to an aspect, there is provided a clamp for a choke, the clamp comprising: a component configured to hold a choke; and at least one electrical connector receiving element for receiving one or more electrical connectors of a choke. Optionally the clamp may include at least one member for securing the clamp to a device.

Because the clamp has elements for holding the electrical connectors of the choke, the electrical connectors of the choke are held in the correct position for connection to the further electrics (e.g. the PCB) of the device. Furthermore, the clamp may include means for securing the choke to the chassis, so meaning that an improved connection may be achieved between the choke and the chassis. This may improve the heat-sink relationship between the choke and the chassis.

### BRIEF DESCRIPTION OF THE DRAWINGS

Specific embodiments are described below by way of example only and with reference to the accompanying drawings, in which:

FIG. 1 shows an example of a choke;

FIG. 2 shows a first embodiment of a clamp for clamping a choke to a chassis;

FIG. 3 shows the clamp of FIG. 2 assembled with the choke of FIG. 1;

FIG. 4 shows an expanded view of the clamp and choke of FIG. 3 being assembled into a chassis;

FIG. 5 shows a perspective view of the clamp and choke of FIG. 3 assembled in a chassis;

FIG. 6 shows a plan view of the busbars and the chassis; and

FIG. 7 shows a perspective view of the assembled choke, clamp, busbars, PCB and chassis.

### OVERVIEW

In overview, a clamp for a choke is provided. The clamp is formed to fit securely around a choke and to align electrical connection of the choke to a printed circuit board. The clamp has features that allow for mating with members on the choke. The clamp may also be used to secure a choke into a chassis and may have features that allow for correct placement of the choke in the chassis.

### DETAILED DESCRIPTION

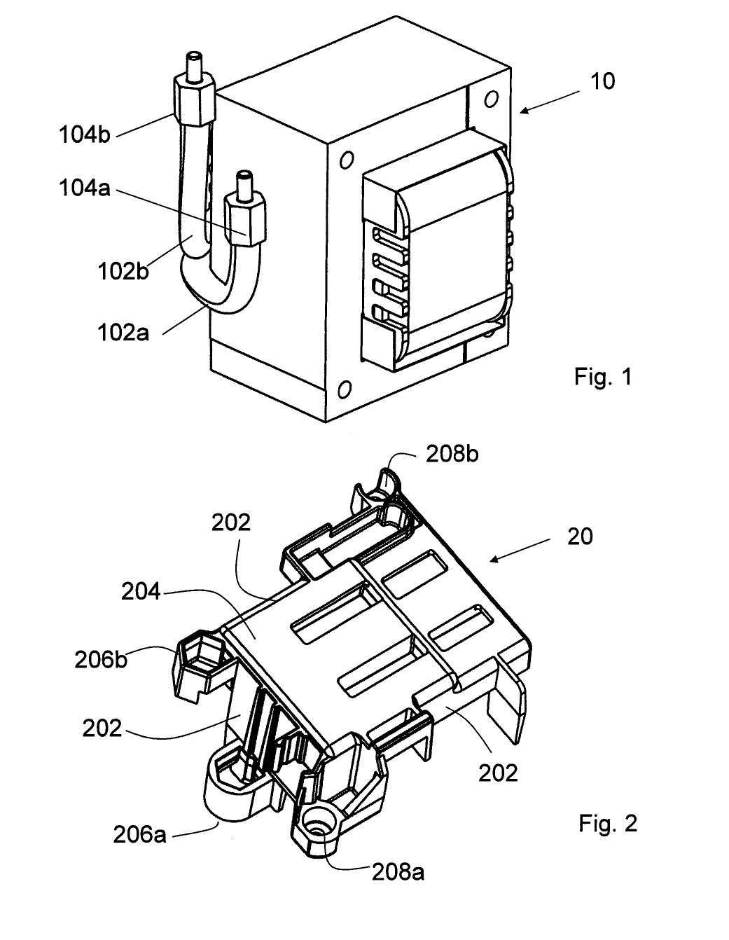

FIG. 1 shows an example of a choke 10 for fitting into a chassis. The choke 10 has choke leads 102a and 102b for the electrical connection of the choke to the electronics of the apparatus in which the choke is fitted. The ends of the choke leads 102a and 102b are each fitted with a connector 104a and 104b for the electrical connection of the choke. In an embodiment, the connectors 104a and 104b may be a M4 threaded pillar soldered to each of the choke leads 102a and 102b.

FIG. 2 shows an embodiment according to this disclosure of a clamp for a choke. The clamp 20 is formed to fit securely around a designated choke. In the embodiment shown, the clamp 20 has sides 202 and a face 204 that fit securely around a choke 10 as shown in FIG. 1. The clamp has at least one element 206a, 206b for receiving the electrical connector 104a, 104b provided at the end of the choke leads 102a, 102b of the choke 10. The clamp may have at least one element 208a, 208b for receiving components (e.g. screws) for fixing the clamp/choke assembly to a chassis.

The clamp may be injection moulded in one part. The clamp may be formed from polycarbonate material or other suitable material.

The positioning of the electrical connector receiving elements 206a, 206b enables the correct positioning of the electrical connectors 104 for electrical connection to the device (e.g. the PCB of the device). The elements 206a, 206b serve to locate the electrical connectors of the choke (e.g. the M4 pillars) such that when assembled in the destination device they are in alignment with associated features of the destination device (e.g. electrical connectors or holes on the PCB of the destination device).

Each electrical connector receiving element 206 shown in FIG. 2 is designed to receive one electrical connector 104 of the choke. It will be apparent to a skilled person that other arrangements of the electrical connector receiving elements 206 are envisaged. For instance, a single electrical connector receiving element 206 may be provided for receiving both electrical connectors 104 in isolation from each other.

The elements 206a, 206b for receiving the electrical connector 104a, 104b provided at the end of the choke leads 102a, 102b may also be positioned to enable both serial and parallel connection of chokes 10. The elements 206a, 206b may be offset. For instance, in the embodiment shown in FIG. 2, element 206a of the clamp is shown further from the face 204 of the clamp than element 206b. The electrical connector 104a, held within element 206a, will therefore, when assembled, be closer to the chassis than the electrical connector 104b, held within element 206b. This allows for a variety of connections between the connectors 104 of the choke. For example, two or more chokes may be connected serially or in parallel.

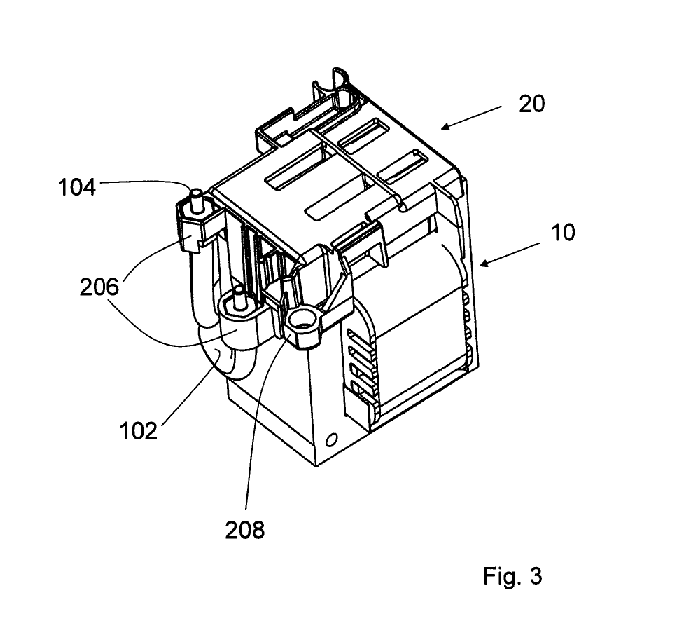

FIG. 3 shows the clamp 20 fitted onto the choke 10, the choke leads 102a, 102b being seen on the left hand side of the Figure. Each connector 104a and 104b at the end of a choke lead 102 fits within an element 206 of the clamp. The positions of the elements 206 serve to locate the connectors 104 correctly within a chassis during assembly.

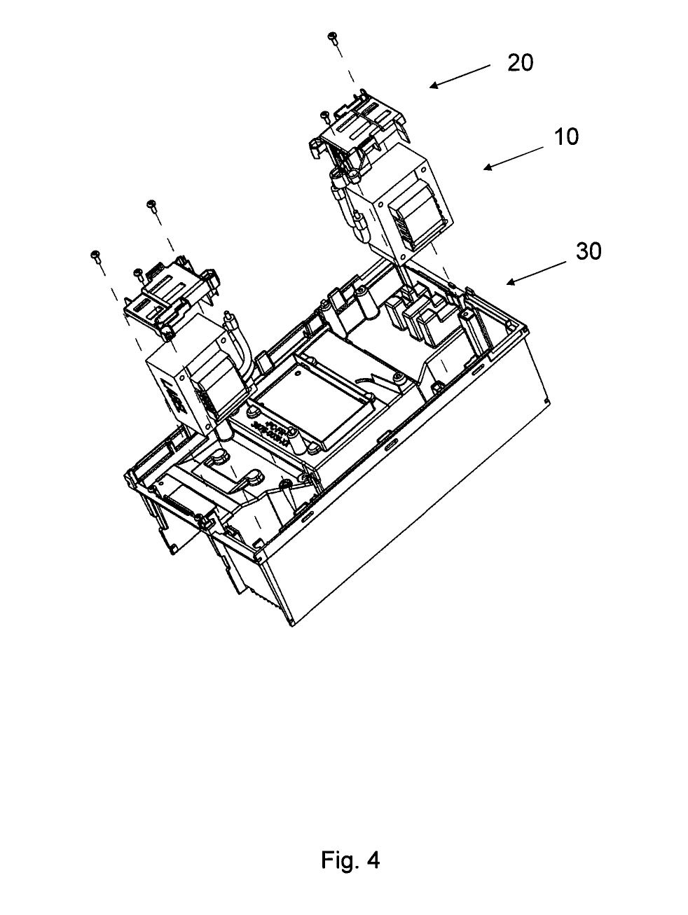

FIG. 4 shows an expanded view of the assembled choke 10 and clamp 20 inserted into a chassis 30. Firstly the clamp 20 is fitted to the choke 10. Then the clamp/choke assembly is placed on the chassis 30. The clamp/choke assembly may then fastened to the chassis 30 by means of screws (e.g. M4 screws) inserted through the elements 208a, 208b.

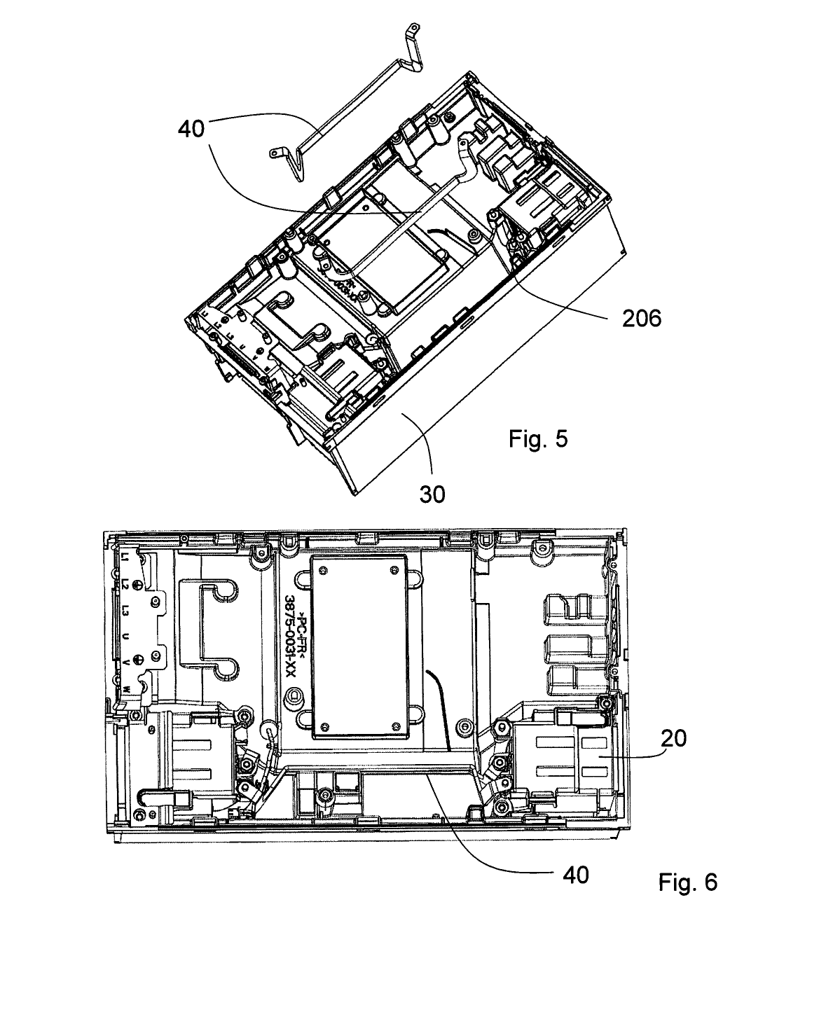

As can been seen in FIGS. 5 and 6, electrical busbars 40 are then installed in electrical connection with the electrical connectors 104a, 104b held within the elements 206. For example, the connectors 104a, 104b are fitted to connectors on the busbars. For example, a hole in the busbar 40 fits over the end of the connector 104. The busbars may be stamped busbars.

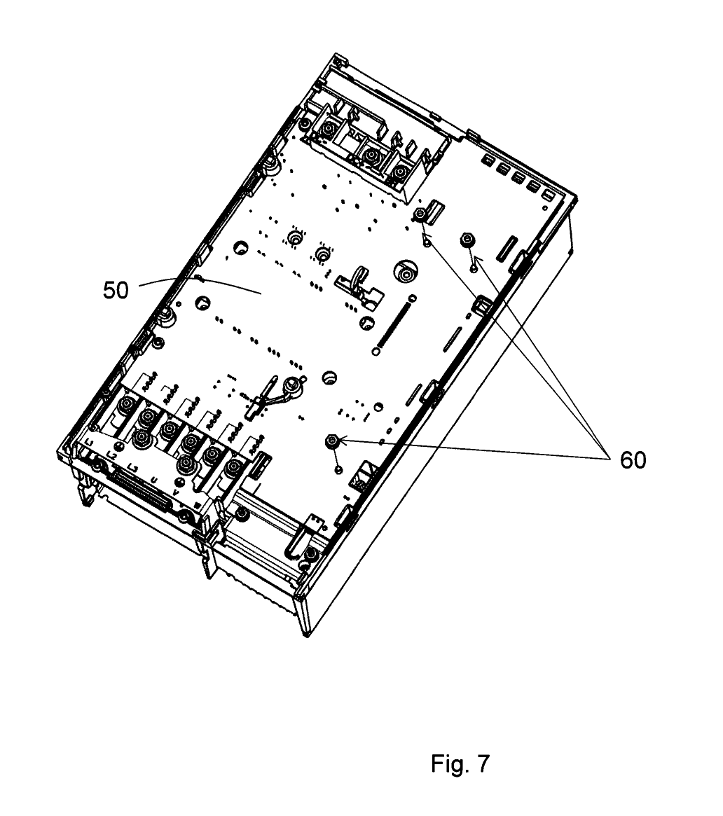

As shown in FIG. 7, a printed circuit board 50 (shown in light grey overlay) is then placed, with the connectors 104 and the busbars 40 in correct position for making contact with the PCB. Securing devices 60 are then fitted to hold the busbars 40 in connection with the connectors 104.

The securing devices 60 may, for instance, be screws or M4 lock nuts that mate with the threaded M4 pillars of the electrical connectors 104. The securing devices 60 serve to clamp the connectors 104 against the main power PCB 50 (via the busbars) to make the electrical connection.

Other securing means may be provided. For instance, the securing devices 60 may be separate from the electrical connector receiving elements 206 and the electrical connectors 104.

Because the connectors 104 are held within the elements 206 of the clamp 20, the connectors are held in the correct place for making the connection to the power PCB. In addition, the provision of a clamp also provides a way of securing the choke to the chassis. The clamp also provides a way of increasing contact between the choke and the chassis to improve the heat-sink relationship of the chassis.

Whilst the above description has shown a clamp with two elements 206a, 206b, it will be apparent to the skilled person that the elements for receiving the ends of the electrical connectors may take other forms. For instance, a single element may be provided, capable of holding the electrical connectors in position. Other variations are also envisaged.

Rather than the clamp being used to secure the choke into a chassis, the choke may be secured to the chassis in other ways. For instance, metal mounting brackets could be fixed to the choke 10. The choke 10 could then be attached and fixed to a chassis (for instance a die-cast aluminum (aluminium) chassis) by using screws to secure the choke mount brackets to the chassis. As an alternative example, the choke 10 may be placed into a cavity in the chassis and then the cavity filled with potting compound to encase the choke 10 and fix it into the chassis 30. The potting compound may serve to improve heat transfer from the choke 10 to the aluminum (aluminium) chassis 30.

The clamp simplifies the process for assembling chokes onto chassis and also allows for correct positioning of the electrical connectors of a choke within a chassis. Furthermore, the clamp may also provide an improved way of securing a choke into a chassis and for the correct positioning of the choke within the chassis.

The clamp allows for enabling electrical connection of the choke to further electrical means in a manner that results in minimal disruption to natural and forced convention, whilst maintaining the choke in a secure manner. Further more, the clamp may allow for securing the choke to a chassis.

1. A clamp for a choke, the clamp comprising:
a component configured to hold a choke; and
at least one electrical connector receiving element for receiving one or more electrical connectors of a choke.

2. A clamp as claimed in claim 1 wherein the component configured to hold a choke comprising sides and a face dimensioned to fit a choke.

3. A clamp as claimed in claim 1 wherein the at least one electrical connector receiving element is arranged to hold electrical connectors in alignment for further connection.

4. A clamp as claimed in claim 1 wherein the at least one electrical connector receiving element is arranged to allow for both serial and parallel connection of two or more chokes.

5. A clamp as claimed in claim 4 wherein the clamp comprise two electrical connector receiving elements per choke and wherein the two electrical connector receiving elements are offset from each other.

6. A clamp as claimed in claim 1 wherein the at least one electrical connector receiving element is shaped to hold the head of an M4 threaded connector.

7. A clamp as claimed in claim 1 further comprising at least one member for securing the clamp to a device.

8. An assembly comprising a clamp and a choke, the clamp comprising a component configured to hold the choke and at least one electrical connector receiving element for receiving one or more electrical connectors of the choke, the assembly comprising the clamp fitted on to the choke.

9. An assembly as claimed in claim 8 wherein the electrical connectors of the choke are inserted into the at least one electrical connector receiving element.

10. An assembly as claimed in claim 8 wherein the clamp further comprises at least one member for securing the clamp to a device.

11. A method of assembling a choke to a device, the method comprising:
assembling a clamp onto a choke, the clamp comprising a component configured to hold the choke and at least one electrical connector receiving element for receiving one or more electrical connectors of the choke, the assembling comprising fitting the clamp on to the choke and inserting the electrical connectors of the choke into the at least one electrical connector receiving element; and
fitting the assembled clamp and choke to a device by securing the assembled clamp and choke assembly to the device and connecting the electrical connectors to electrical connectors of the device.

12. A method as claimed in claim 11 wherein the clamp further comprises at least one member for securing the clamp to the device and wherein the method further comprises securing the assembled clamp and choke assembly to the device by means of the member for securing.

13. A method as claimed in claim 11 wherein the device is a chassis.

14. A method as claimed in claim 11 wherein the device is an aluminum chassis

15. A clamp for a choke substantially as described herein with reference to the accompanying drawings.
